(19) United States
(12) Patent Application Publication
(10) Pub. No.: US 2026/0216971 A1
(43) Pub. Date: Jul. 30, 2026

(54) ROTOR BLADE MOLD AND METHOD OF MANUFACTURING ROTOR BLADE USING SAME

(71) Applicants: Michael BELOTE, Kolding (DK); LM Wind Power A/S, Kolding (DK)

(72) Inventors: Michael Belote, Little Rock, AR (US); Rasmus C. Ostergaard, Copenhagen (DK); Stefaan Guido Van Nieuwenhove, Medemblik (NL); Ayse Deniz Memisoglu, Kolding (DK)

(21) Appl. No.: 19/143,548

(22) PCT Filed: Dec. 27, 2022
(86) PCT No.: PCT/US2022/054064

§ 371 Date: Jun. 26, 2025

(51) Int. Cl. B29C 70/48; B29C 33/30; B29C 70/44; B29L 31/08

(52) U.S. Cl. CPC B29C 70/48; B29C 33/306; B29C 70/443; B29L 2031/085

(57) ABSTRACT

A method of manufacturing a rotor blade of a wind turbine using a mold assembly includes placing a first blade segment in a reusable mold portion; placing and securing a reusable spar fixture within a custom intermediate mold portion; placing a spar cap atop the custom intermediate mold portion and the reusable spar fixture; placing blade skins in the custom intermediate mold portion and/or around a portion of the spar caps; placing a second blade segment around a portion of the spar caps; aligning the first blade segment with a first end of the blade skins; aligning a second end of the blade skins with a first end of the second blade segment; providing a vacuum only within the custom intermediate mold portion; infusing the blade skins with a resin to join the first blade segment, the blade skins, and the second blade segment together to form the rotor blade.

### FIELD

The present disclosure relates generally to wind turbines, and more particularly to rotor blade molds for wind turbines and methods of manufacturing the rotor blades using same.

### BACKGROUND

Wind power is considered one of the cleanest, most environmentally friendly energy sources presently available, and wind turbines have gained increased attention in this regard. A modern wind turbine typically includes a tower, a generator, a gearbox, a nacelle, and a rotor having a rotatable hub with one or more wind turbine blades. The wind turbine blades capture kinetic energy of wind using known airfoil principles. The wind turbine blades transmit the kinetic energy in the form of rotational energy so as to turn a shaft coupling the wind turbine blades to a gearbox, or if a gearbox is not used, directly to the generator. The generator then converts the mechanical energy to electrical energy that may be deployed to a utility grid. Thus, the amount of electrical energy that can be deployed to the grid is dependent on the amount of mechanical energy that can be captured by the wind turbine. To this end, wind turbine blades have continued to increase in size, and consequently weight, to capture greater amounts of mechanical energy.

The wind turbine blades generally include a suction side shell and a pressure side shell typically formed using molding processes that are bonded together at bond lines along the leading and trailing edges of the blade. The body shell is typically reinforced using one or more structural components (e.g., opposing spar caps with a shear web configured therebetween) that engage the inner pressure and suction side surfaces of the shell halves. Many wind turbine blades often also include a leading-edge bond cap positioned at the leading edge of the wind turbine blade between the suction side and pressure side shells.

The spar caps are typically constructed of various materials, including but not limited to glass fiber laminate composites and/or carbon fiber laminate composites. The shell of the wind turbine blade is generally built around the spar caps of the blade by stacking layers of fiber fabrics in a shell mold. The layers are then typically infused together with a resin.

As wind turbine blades continue to increase in size, conventional infusion processes experience challenges for larger blade production (e.g., wind turbine blades exceeding 90 meters). Such challenges may include, for example, having to build large custom molds to accommodate the growing size of the rotor blades, which is both time consuming and expensive. In addition, custom or bespoke molds typically cannot be reused.

Thus, modern methods for manufacturing wind turbine blades may include forming the blades in segments that may be assembled within a mold and infused together to form the blade. For example, some modern wind turbine blades have a modular panel configuration, such as those wind turbine blades described in U.S. patent application Ser. No. 14/753,137 filed Jun. 29, 2015, and entitled “Modular Wind Turbine Wind turbine blades and Methods of Assembling Same,” which is incorporated herein by reference in its entirety.

In view of the foregoing, the art is continually seeking new and improved methods for manufacturing wind turbine rotor blades.

### BRIEF DESCRIPTION

Aspects and advantages of the invention will be set forth in part in the following description, or may be obvious from the description, or may be learned through practice of the invention.

In one aspect, the present disclosure is directed to a method of manufacturing a rotor blade of a wind turbine using a mold assembly. The method includes placing at least one first blade segment in a reusable first mold portion of the mold assembly. The method also includes placing and securing a reusable spar fixture of the mold assembly within a custom intermediate mold portion of the mold assembly, the custom intermediate mold portion extending from a first end to a second end, the reusable spar fixture extending beyond the second end of the custom intermediate mold portion. The method also includes placing one or more spar caps atop, at least, the custom intermediate mold portion and the reusable spar fixture. The method also includes placing one or more blade skins in the custom intermediate mold portion and/or around at least a portion of the one or more spar caps. The method also includes placing at least one second blade segment around at least a portion of the one or more spar caps atop the reusable spar fixture. The method also includes aligning the at least one first blade segment placed in the reusable first mold portion with a first end of the one or more blade skins placed in the custom intermediate mold portion. The method also includes aligning a second end of the one or more blade skins placed in the custom intermediate mold portion with a first end of the at least one second blade segment placed around at least the portion of the one or more spar caps atop the reusable spar fixture. The method also includes providing a vacuum only within the custom intermediate mold portion. The method also includes infusing the one or more blade skins under the vacuum with a resin to join the at least one first blade segment, the one or more blade skins, and the at least one second blade segment together to form the rotor blade.

In an embodiment, aligning the at least one first blade segment placed in the reusable first mold portion with the first end of the one or more blade skins placed in the custom intermediate mold portion further includes placing the first end of the one or more blade skins within the reusable first mold portion.

In further embodiments, the method further includes providing the vacuum only within the custom intermediate mold portion and not to remaining portions of the mold assembly.

In additional embodiments, the reusable first mold portion is a reusable blade root mold and the at least one first blade segment includes a prefabricated root section.

In other embodiments, the at least one second blade segment includes a blade tip section.

In still further embodiments, the reusable spar fixture is a rod-shaped member.

In other additional embodiments, after the infusing, the one or more blade skins infused with the resin form at least one of a trailing edge segment, a leading edge segment, a suction side segment, a pressure side segment, or combinations thereof.

In another aspect, the present disclosure is directed to a method of manufacturing a rotor blade of a wind turbine using a mold assembly. The method includes placing and securing a reusable spar fixture of the mold assembly within a custom mold portion of the mold assembly, the custom mold portion extending from a first end to a second end, the reusable spar fixture extending beyond the second end of the custom mold portion. The method also includes placing one or more spar caps atop, at least, the custom mold portion and the reusable spar fixture. The method also includes placing one or more blade skins in the custom mold portion and/or around at least a portion of the one or more spar caps. The method also includes placing at least one blade segment around at least a portion of the one or more spar caps atop the reusable spar fixture. The method also includes aligning an end of the one or more blade skins placed in the custom mold portion with an end of the at least one blade segment placed around at least the portion of the one or more spar caps atop the reusable spar fixture. The method also includes providing a vacuum only within the custom mold portion. The method also includes infusing the one or more blade skins under the vacuum with a resin to join the one or more blade skins and the at least one blade segment together to form the rotor blade.

In further additional embodiments, the method further includes placing the custom mold portion at least partially within a reusable mold portion, wherein the reusable mold portion is a reusable blade root mold and the at least one blade segment includes a prefabricated root section; placing at least one prefabricated root section in the reusable blade root mold of the mold assembly; and co-infusing the at least one prefabricated blade root section with the one or more blade skins.

In another aspect, the present disclosure is directed to a mold assembly for manufacturing a rotor blade of a wind turbine. The mold assembly includes a reusable first mold portion; a custom intermediate mold portion defining a custom contoured surface corresponding to a portion of an exterior surface of the rotor blade, the custom intermediate mold portion extending from a first end and a second end, the first end being received and supported within the reusable first mold portion, the custom intermediate mold portion configured to receive one or more blade skins; an infusion apparatus including a resin for infusing the one or more blade skins and a vacuum assembly for applying a vacuum only to the custom intermediate mold portion to draw the resin into the one or more blade skins; and a reusable spar fixture secured within the custom intermediate mold portion, wherein a portion of the reusable spar fixture extends past the second end of the custom intermediate mold portion to support at least one of one or more spar caps or one or more blade segments thereon during the manufacturing of the rotor blade.

In still other embodiments, the reusable blade root mold is configured to support a prefabricated root section.

In yet other embodiments, the mold assembly further includes a support structure arranged beneath the reusable spar fixture for supporting the portion of the reusable spar fixture extending beyond the custom intermediate mold portion.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of an embodiment of a wind turbine according to the present disclosure;

FIG. 2 illustrates a perspective view of an embodiment of a wind turbine blade of a wind turbine according to the present disclosure;

FIG. 3 illustrates an exploded view of the modular wind turbine blade of FIG. 2;

FIG. 4 illustrates a cross-sectional view of an embodiment of a leading-edge segment of a modular wind turbine blade according to the present disclosure;

FIG. 5 illustrates a cross-sectional view of an embodiment of a trailing edge segment of a modular wind turbine blade according to the present disclosure;

FIG. 6 illustrates a cross-sectional view of the modular wind turbine blade of FIG. 2 along section line 6-6 according to the present disclosure;

FIG. 7 illustrates a cross-sectional view of the modular wind turbine blade of FIG. 2 along section line 7-7 according to the present disclosure;

FIG. 8 illustrates a perspective view of another embodiment of a rotor blade of a wind turbine according to the present disclosure;

FIG. 9 illustrates a flow diagram of an embodiment of a method of manufacturing a rotor blade of a wind turbine using a mold assembly according to the present disclosure;

FIG. 10 illustrates a perspective view of an embodiment of a mold assembly of a rotor blade of a wind turbine according to the present disclosure; and

FIG. 11 illustrates a perspective view of another embodiment of a mold assembly of a rotor blade of a wind turbine according to the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present disclosure is directed to systems and methods manufacturing rotor blades of wind turbines using a mold assembly. In an embodiment, for example, the mold assembly includes a reusable first mold portion, a custom intermediate mold portion, and a reusable spar fixture. Thus, in an embodiment, the mold assembly may include one or more portions that are reusable for multiple rotor blades and a smaller mold portion that is customizable for a particular rotor blade. More specifically, in an embodiment, the reusable first mold portion, which may be a blade root mold portion, can be aligned with the custom intermediate mold portion. Further, in an embodiment, the reusable spar fixture can be aligned with the custom intermediate mold portion at an opposing side from the reusable first mold portion. As such, in an embodiment, the reusable spar fixture can extend beyond an end of the custom intermediate mold portion once aligned.

As such, in an embodiment, a rotor blade can be manufactured using the mold assembly. In particular embodiments, for example, the rotor blade can be formed by placing at least one first blade segment, such as a prefabricated blade root section, in the blade root mold portion and placing one or more spar caps atop, at least, the custom intermediate mold portion and the reusable spar fixture. Further, one or more blade skins may be placed in the custom intermediate mold portion and/or around at least a portion of the spar cap(s). Moreover, at least one second blade segment may be placed around at least a portion of the spar cap(s) atop the reusable spar fixture. As such, the blade root mold portion can be aligned with a first end of the blade skin(s) placed in the custom intermediate mold portion and a second end of the blade skin(s) can be aligned with a first end of the second blade segment(s). Accordingly, a vacuum can be applied only within the custom intermediate mold portion. Under vacuum, the blade skin(s) can then be infused with a resin to join the prefabricated blade root section, the blade skin(s), and the second blade segment(s) together to form the rotor blade.

As such, the systems and methods of the present disclosure minimize the size (and therefore cost) of the portion of the mold that must be under vacuum and infused. Moreover, the present disclosure includes using reusable mold portions that can be reused for manufacturing multiple rotor blades, thereby improving manufacturing efficiency and reducing costs.

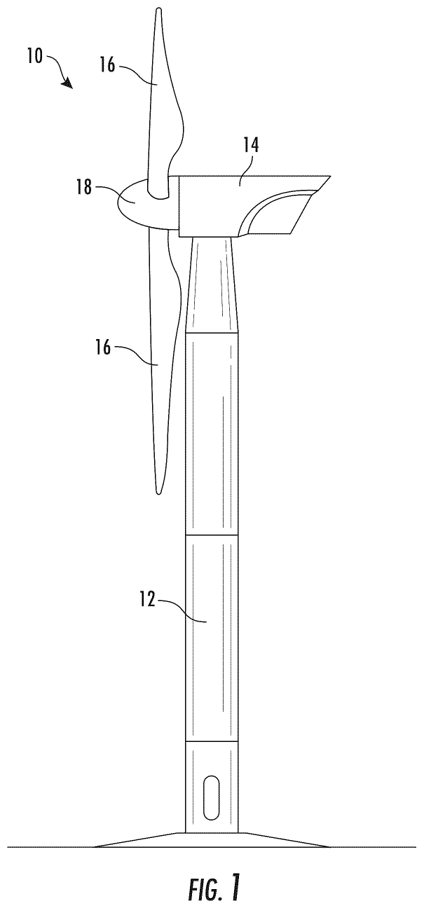

Referring now to the drawings, FIG. 1 illustrates a perspective view of an embodiment of a wind turbine 10 according to the present disclosure. As shown, the wind turbine 10 includes a tower 12 with a nacelle 14 mounted thereon. A plurality of wind turbine blades 16 are mounted to a rotor hub 18, which is in turn connected to a main flange that turns a main rotor shaft. The wind turbine power generation and control components are housed within the nacelle 14. The view of FIG. 1 is provided for illustrative purposes only to place the present invention in an exemplary field of use. It should be appreciated that the invention is not limited to any particular type of wind turbine configuration. In addition, the present invention is not limited to use with wind turbines, but may be utilized in any application that involves the assembly of wind turbine blades.

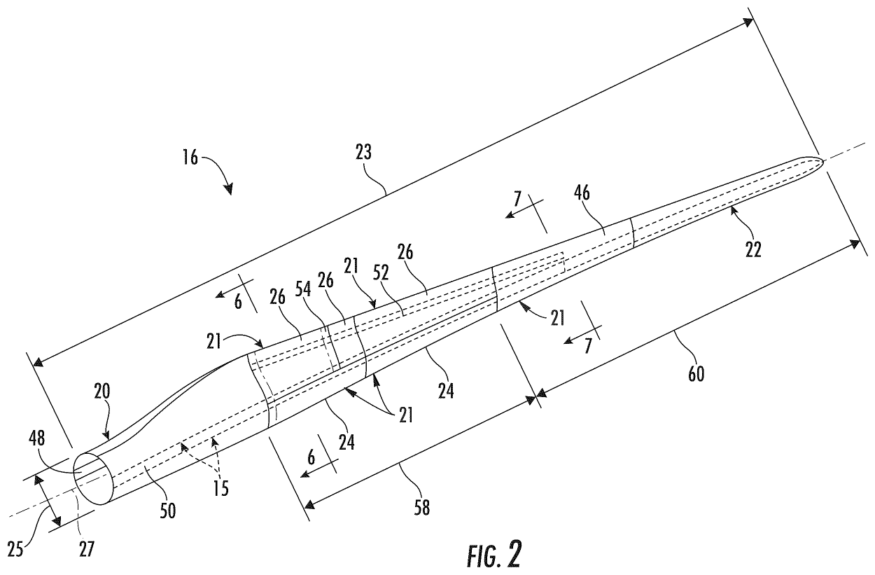

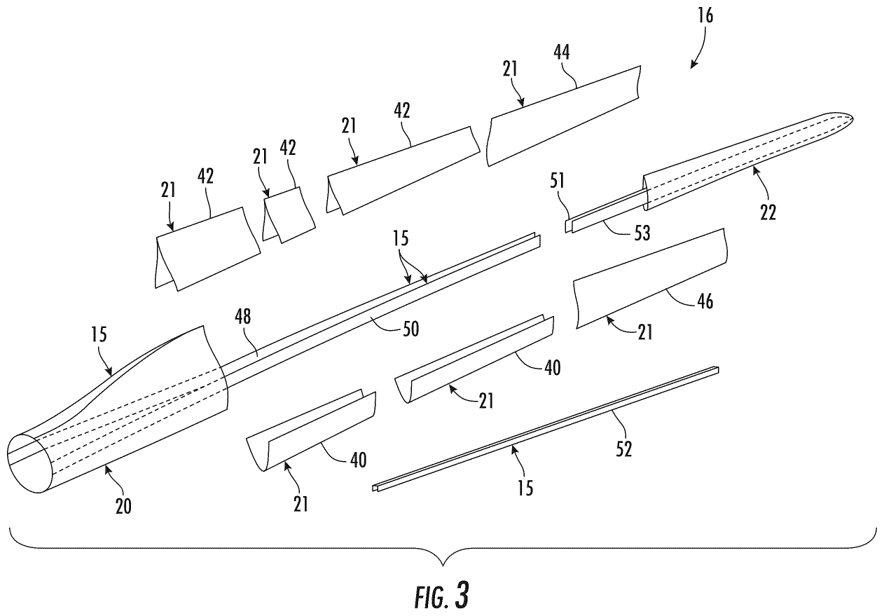

Referring now to FIGS. 2 and 3, various views of a wind turbine blade 16 according to the present disclosure are illustrated. As shown, the illustrated wind turbine blade 16 has a segmented or modular configuration. It should also be understood that the wind turbine blade 16 may include any other suitable configuration now known or later developed in the art. As shown, the modular wind turbine blade 16 includes a main blade structure 15 and at least one blade segment 21 secured to the main blade structure 15. More specifically, as shown, the wind turbine blade 16 includes a plurality of blade segments 21.

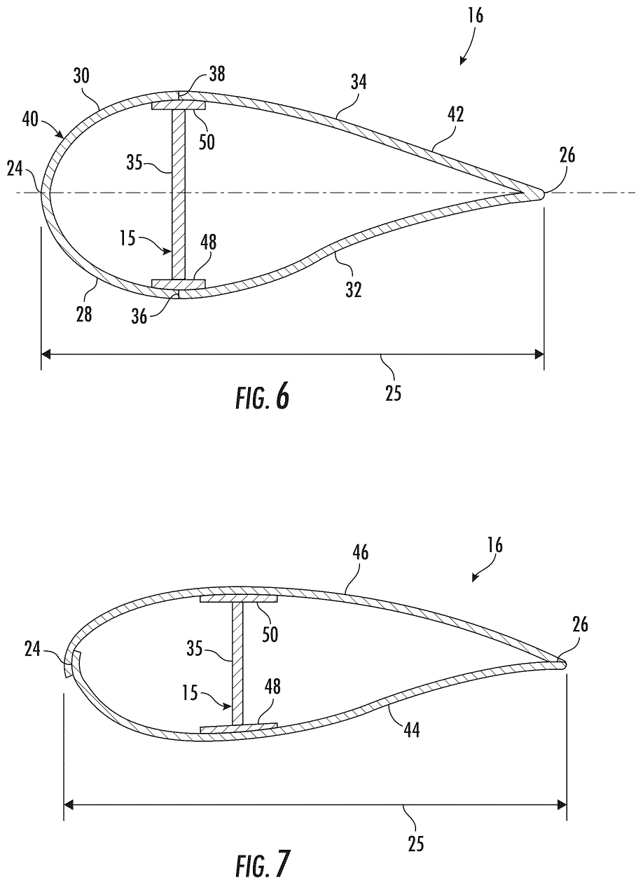

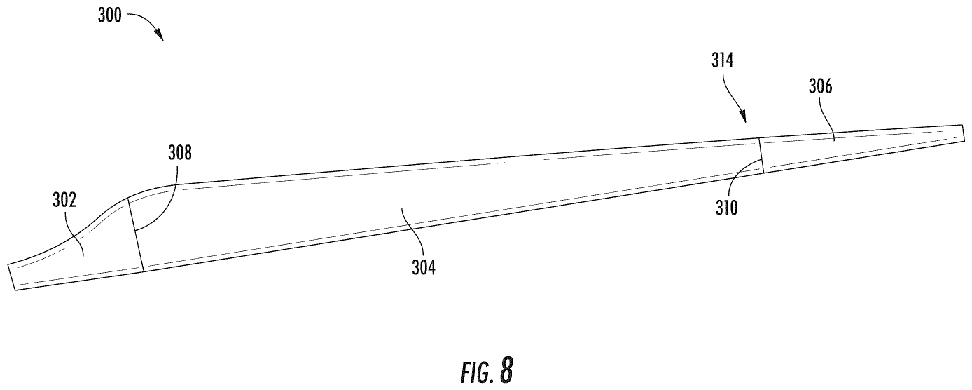

More specifically, as shown, the main blade structure 15 may include any one of or a combination of the following: a pre-formed blade root section 20, a pre-formed blade tip section 22, one or more one or more continuous spar caps 48, 50, 51, 53, one or more shear webs 35 (FIGS. 6-7), an additional structural component 52 secured to the blade root section 20, and/or any other suitable structural component of the wind turbine blade 16. Further, the blade root section 20 is configured to be mounted or otherwise secured to the rotor 18 (FIG. 1). In addition, as shown in FIG. 2, the wind turbine blade 16 defines a span 23 that is equal to the total length between the blade root section 20 and the blade tip section 22. As shown in FIGS. 2 and 6, the wind turbine blade 16 also defines a chord 25 that is equal to the total length between a leading edge 24 of the wind turbine blade 16 and a trailing edge 26 of the wind turbine blade 16. As is generally understood, the chord 25 may generally vary in length with respect to the span 23 as the wind turbine blade 16 extends from the blade root section 20 to the blade tip section 22.

Referring particularly to FIGS. 2-4, any number of blade segments 21 or panels (also referred to herein as blade shells) having any suitable size and/or shape may be generally arranged between the blade root section 20 and the blade tip section 22 along a longitudinal axis 27 in a generally span-wise direction. Thus, the blade segments 21 generally serve as the outer casing/covering of the wind turbine blade 16 and may define a substantially aerodynamic profile, such as by defining a symmetrical or cambered airfoil-shaped cross-section.

In additional embodiments, it should be understood that the blade segment portion of the blade 16 may include any combination of the segments described herein and are not limited to the embodiment as depicted. More specifically, in certain embodiments, the blade segments 21 may include any one of or combination of the following: pressure and/or suction side segments 44, 46, (FIGS. 2 and 3), leading and/or trailing edge segments 40, 42 (FIGS. 2-6), a non-jointed segment, a single-jointed segment, a multi-jointed blade segment, a J-shaped blade segment, or similar.

More specifically, as shown in FIG. 4, the leading-edge segments 40 may have a forward pressure side surface 28 and a forward suction side surface 30.

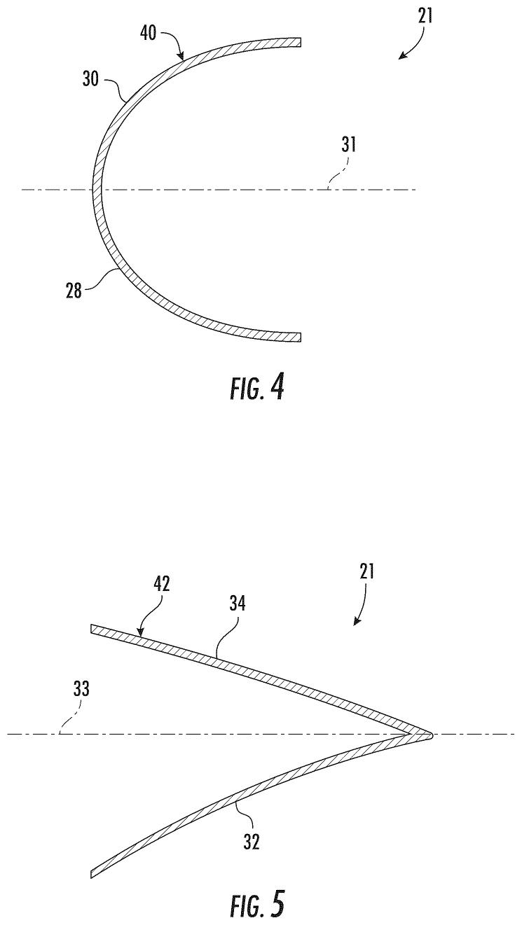

Similarly, as shown in FIG. 5, each of the trailing edge segments 42 may have an aft pressure side surface 32 and an aft suction side surface 34. Thus, the forward pressure side surface 28 of the leading-edge segment 40 and the aft pressure side surface 32 of the trailing edge segment 42 generally define a pressure side surface of the wind turbine blade 16. Similarly, the forward suction side surface 30 of the leading-edge segment 40 and the aft suction side surface 34 of the trailing edge segment 42 generally define a suction side surface of the wind turbine blade 16. In addition, as particularly shown in FIG. 6, the leading-edge segment(s) 40 and the trailing edge segment(s) 42 may be joined at a pressure side seam 36 and a suction side seam 38. For example, the blade segments 40, 42 may be configured to overlap at the pressure side seam 36 and/or the suction side seam 38. Further, as shown in FIG. 2, adjacent blade segments 21 may be configured to overlap at a seam 54. Alternatively, in certain embodiments, the various segments of the wind turbine blade 16 may be secured together via an adhesive (or mechanical fasteners) configured between the overlapping leading and trailing edge segments 40, 42 and/or the overlapping adjacent leading or trailing edge segments 40, 42.

In specific embodiments, as shown in FIGS. 2-3 and 6-7, the blade root section 20 may include one or more longitudinally extending spar caps 48, 50 infused therewith. For example, the blade root section 20 may be configured according to U.S. application Ser. No. 14/753,155 filed Jun. 29, 2015, entitled “Blade Root Section for a Modular Wind turbine blade and Method of Manufacturing Same” which is incorporated herein by reference in its entirety.

Similarly, the blade tip section 22 may include one or more longitudinally extending spar caps 51, 53 infused therewith. More specifically, as shown, the spar caps 48, 50, 51, 53 may be configured to be engaged against opposing inner surfaces of the blade segments 21 of the wind turbine blade 16. Further, the blade root spar caps 48, 50 may be configured to align with the blade tip spar caps 51, 53. Thus, the spar caps 48, 50, 51, 53 may generally be designed to control the bending stresses and/or other loads acting on the wind turbine blade 16 in a generally span-wise direction (a direction parallel to the span 23 of the wind turbine blade 16) during operation of a wind turbine 10. In addition, the spar caps 48, 50, 51, 53 may be designed to withstand the span-wise compression occurring during operation of the wind turbine 10. Further, the spar cap(s) 48, 50, 51, 53 may be configured to extend from the blade root section 20 to the blade tip section 22 or a portion thereof. Thus, in certain embodiments, the blade root section 20 and the blade tip section 22 may be joined together via their respective spar caps 48, 50, 51, 53.

Referring to FIGS. 6-7, one or more shear webs 35 may be configured between the one or more spar caps 48, 50, 51, 53. More particularly, the shear web(s) 35 may be configured to increase the rigidity in the blade root section 20 and/or the blade tip section 22. Further, the shear web(s) 35 may be configured to close out the blade root section 20.

In addition, as shown in FIGS. 2 and 3, the additional structural component 52 may be secured to the blade root section 20 and extend in a generally span-wise direction so as to provide further support to the wind turbine blade 16. For example, the structural component 52 may be configured according to U.S. application Ser. No. 14/753,150 filed Jun. 29, 2015, entitled “Structural Component for a Modular Wind turbine blade” which is incorporated herein by reference in its entirety. More specifically, the structural component 52 may extend any suitable distance between the blade root section 20 and the blade tip section 22. Thus, the structural component 52 is configured to provide additional structural support for the wind turbine blade 16 as well as an optional mounting structure for the various blade segments 21 as described herein. For example, in certain embodiments, the structural component 52 may be secured to the blade root section 20 and may extend a predetermined span-wise distance such that the leading and/or trailing edge segments 40, 42 can be mounted thereto.

Referring now to FIG. 8, a perspective view of an embodiment of a rotor blade 300 of a wind turbine is illustrated. As shown, the rotor blade 300 includes a blade root section 302, at least one intermediate blade section 304, and a blade tip section 306. The blade root 302 may be attached to the intermediate blade section 304 at a first interface 308. The intermediate blade section 304 may be attached to the blade tip section 306 at a second interface 310. Each of the interfaces 308, 310 may be formed using a mold assembly that will be discussed hereinbelow.

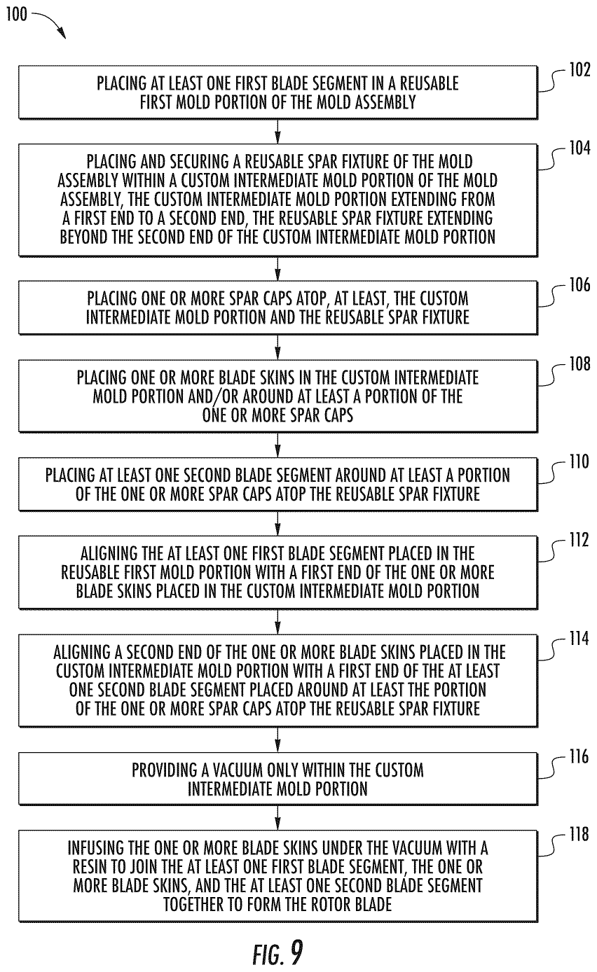

Referring generally to FIGS. 9-11, systems and methods of assembling a rotor blade of a wind turbine, such as a rotor blade 300, according to the present disclosure are illustrated. Referring particularly to FIG. 9, a flow diagram of an embodiment of a method 100 of assembling a wind turbine blade, such as rotor blade 300, are illustrated. However, although the method 100 will be described as specifically assembling rotor blade 300 which may be part of a wind turbine, the method 100 may also be employed to assemble any other suitable rotor blades in another other suitable application. Although FIG. 9 depicts steps performed in a particular order for purposes of illustration and discussion, the methods described herein are not limited to any particular order or arrangement. One skilled in the art, using the disclosures provided herein, will appreciate that various steps of the methods can be omitted, rearranged, combined and/or adapted in various ways.

Referring particularly to FIG. 9, as shown at (102), the method 100 includes placing at least one first blade segment in a reusable first mold portion of the mold assembly. For example, the reusable first mold portion may be a reusable blade root mold portion and the first blade segment(s) may include a prefabricated root section.

As shown at (104), the method 100 includes placing and securing a reusable spar fixture of the mold assembly within a custom intermediate mold portion of the mold assembly. In such embodiments, the custom intermediate mold portion may generally extend from a first end to a second end. Thus, in an embodiment, the reusable spar fixture extends beyond the second end of the custom intermediate mold portion. Further, in an embodiment, the reusable spar fixture may be a rod-shaped member.

As shown at (106), the method 100 includes placing one or more spar caps atop, at least, the custom intermediate mold portion and the reusable spar fixture. As shown at (108), the method 100 includes placing one or more blade skins in the custom intermediate mold portion and/or around at least a portion of the one or more spar caps. Furthermore, as shown at (110), the method 100 includes placing at least one second blade segment around at least a portion of the spar cap(s) atop the reusable spar fixture. For example, in an embodiment, the second blade segment(s) may be a blade tip section.

Still referring to FIG. 9, as shown at (112), the method 100 includes aligning the first blade segment(s) placed in the reusable first mold portion with a first end of the blade skin(s) placed in the custom intermediate mold portion. For example, in an embodiment, aligning the first blade segment(s) placed in the reusable first mold portion with the first end of the blade skin(s) placed in the custom intermediate mold portion may further include placing the first end of the blade skin(s) within the reusable first mold portion.

As shown at (114), the method 100 further includes aligning a second end of the blade skin(s) placed in the custom intermediate mold portion with a first end of the second blade segment(s) placed around at least the portion of the spar cap(s) atop the reusable spar fixture. As shown at (116), the method 100 also includes providing a vacuum only within the custom intermediate mold portion. For example, the vacuum may be provided only within the custom intermediate mold portion and not to remaining portions of the mold assembly. Accordingly, as shown at (118), the method 100 includes infusing the blade skin(s) under the vacuum with a resin to join the first blade segment(s), the blade skin(s), and the second blade segment(s) together to form the rotor blade. In addition, after infusing, the blade skin(s) infused with the resin may form at least one of a trailing edge segment, a leading-edge segment, a suction side segment, a pressure side segment, or combinations thereof.

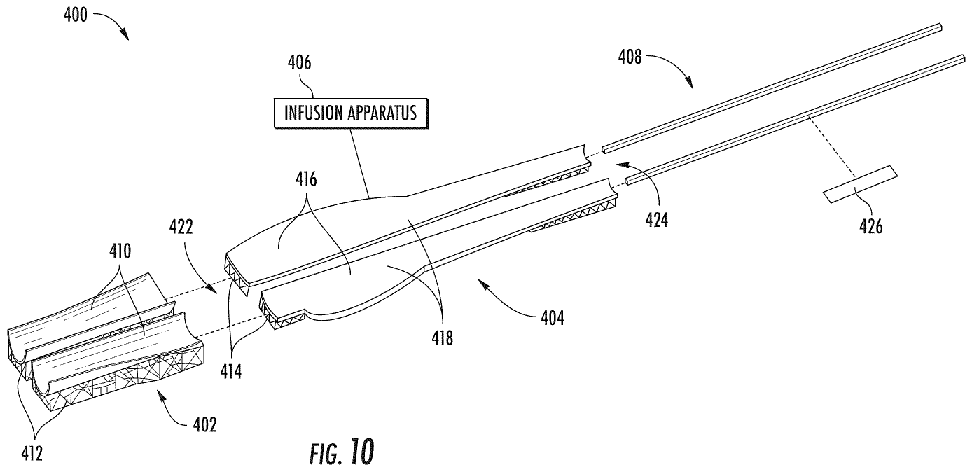

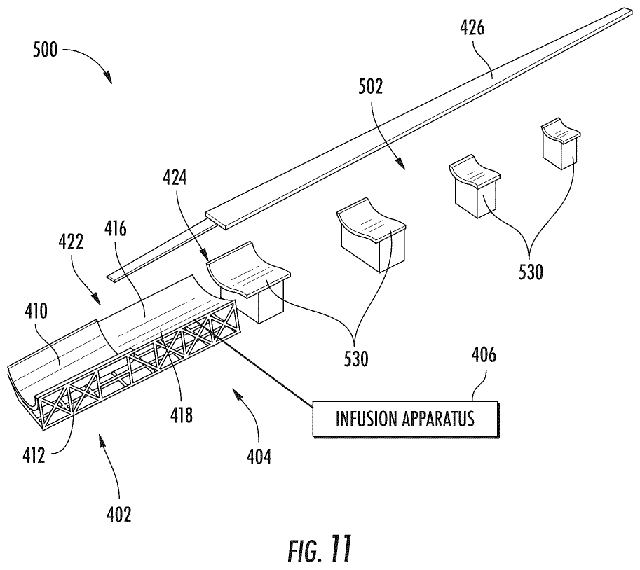

The method 100 of FIG. 9 may be better understood with respect to FIGS. 10 and 11 described herein below. Referring particularly to FIG. 11, a mold assembly 400 of a rotor blade of a wind turbine is illustrated according to the present disclosure. As shown in FIG. 10, the mold assembly 400 includes a reusable first mold portion 402, a custom intermediate mold portion 404, and a reusable spar fixture 408.

Moreover, as shown, the mold assembly 400 may include an infusion apparatus 406.

In particular embodiments, as shown, the reusable first mold portion 402 may be a blade root mold portion 410 supported by a mold support base 412. Thus, as shown, the blade root mold portion 410 may have a contour that generally corresponds to a contour of a first blade segment, such as the blade root section 302 in FIG. 8. Accordingly, in an embodiment, the blade root mold portion 410 is configured to support the prefabricated blade root section 302. Since the majority of rotor blades have a common or similar blade root section, the blade root mold portion 410 can be used and reused to form multiple rotor blades and is not required to be bespoke.

Referring still to FIG. 10, the custom intermediate mold portion 404 may also include a mold support base 414 and a custom intermediate mold surface 416. In contrast to the reusable blade root mold portion 410, however, the custom intermediate mold surface 416 can be tailored to a particular rotor blade and has to customized for each blade that is manufactured using the mold assembly 400 described herein. Thus, as shown, the custom intermediate mold surface 416 includes a unique contour specific to a particular rotor blade. For example, the custom intermediate mold surface 416 may correspond to a portion of an exterior surface of a particular rotor blade. Furthermore, in an embodiment, the custom intermediate mold portion 404 may also extend from a first end 422 to a second end 424. In addition, the custom intermediate mold portion 404 may be placed, at least partially, within the reusable first mold portion 402. For example, the first end 422 of the custom intermediate mold 404 may be received and supported within the reusable first mold portion 402. As such, when manufacturing the rotor blade 300, one or more blade skins 418 may be placed atop the custom intermediate mold surface 416 and may overlap at least a portion of the reusable first mold portion 402.

As mentioned, the mold assembly 400 also includes the reusable spar fixture 408. Thus, in an embodiment, the reusable spar fixture 408 can be received within the custom intermediate mold portion 404 and may extend beyond the second end 424 thereof. Further, in an embodiment, the reusable spar fixture 408 is configured to support one or more spar caps and/or one or more intermediate blade segments thereon during manufacturing of the rotor blade 300. In particular embodiments, as shown in FIG. 10, the reusable spar fixture 408 may be a rod-shaped member. In such embodiments, the rod-shaped member may be adaptable or bendable to fit with the custom intermediate mold portion 404. Furthermore, in an embodiment, the reusable spar fixture 408 may also be constructed of a variety of materials, such as a metal material or a composite material. In alternative embodiments, as shown in FIG. 11, the reusable spar fixture 408 may include a plurality of fixture segments 530 placed adjacent to the custom intermediate mold portion 404.

Moreover, as shown in FIGS. 10 and 11, the different components of the mold assembly 400 (e.g., the blade root mold portion 410, the custom intermediate mold portion 404, and the reusable spar fixture 408) can be generally aligned in a spanwise direction. Once aligned, at least one first blade segment, such as the blade root segment 302, may be placed in the reusable first mold portion 410 of the mold assembly 400. Further, one or more spar structures, such as spar caps 48, 50, 51, 53 (FIGS. 3 and 6-7), may be placed atop the custom intermediate mold portion 404 and/or the reusable spar fixture 408 of the mold assembly 400. Further, in an embodiment, the blade skin(s) 418 may be placed in the custom intermediate mold portion 404 and/or around at least a portion of the spar caps. In certain embodiments, the blade skin(s) 418 may include any material suitable, such as glass fibers, carbon fibers, etc. to be infused with a resin to form the rotor blade 300 or various parts thereof.

In another embodiment, at least one second blade segment can then be placed around at least a portion of the spar caps atop the reusable spar fixture 408. Further, in an embodiment, the blade root segment 302 can be aligned with a first end of the blade skin(s) 418 and a second end of the blade skin(s) 418 can be aligned with a first end of the blade tip segment 306. Thus, a vacuum can be applied only within the custom intermediate mold portion 404 to draw the resin through the blade skin(s) 418.

Thus, in an embodiment, the blade skin(s) 418 under vacuum may be infused with a resin by the infusion apparatus 406 to join the blade root segment 302, the blade skin(s) 418, and the blade tip segment 306 together to form the rotor blade. For example, in an embodiment, the infusion apparatus 406 may include a resin dispenser, a vacuum apparatus, a means to cure the resin after being infused into the blade skins 418. Further, in an embodiment, the prefabricated blade root section 410 may be co-infused with the blade skin(s) 418 to form a single part. After being infused and/or cured, the infused blade skins 418 may form a blade segment 426. For example, in certain embodiments, the blade segment 426 may be a trailing edge segment 42, a leading-edge segment 40, a suction side segment 34, a pressure side segment 28, or combinations thereof.

Referring particularly to FIG. 11, another embodiment of a mold assembly 500 for a rotor blade of a wind turbine is illustrated. Similar to the embodiment of FIG. 10, as shown, the mold assembly 500 includes the reusable first mold portion 402, the custom intermediate mold portion 404, and a reusable spar fixture 502.

However, as shown, the reusable spar fixture 502 may be placed adjacent the custom intermediate mold portion 404 and may include a plurality of fixture segments 530 (e.g., rather than being a rod-shaped member). By providing multiple fixture segments 530, the length and/or size of the reusable spar fixture 502 may be adjusted depending on the one or more blade segments to be attached. Further, in an embodiment, the fixture segments 530 may be aligned in an end-to-end configuration and may be placed directly beside each other or may be spaced apart from each other (as shown in FIG. 11) for supporting the spar caps and/or blade segments as described herein.

Various aspects and embodiments of the present invention are defined by the following numbered clauses:
Clause 1. A method of manufacturing a rotor blade of a wind turbine using a mold assembly, the method comprising:
placing at least one first blade segment in a reusable first mold portion of the mold assembly;
placing and securing a reusable spar fixture of the mold assembly within a custom intermediate mold portion of the mold assembly, the custom intermediate mold portion extending from a first end to a second end, the reusable spar fixture extending beyond the second end of the custom intermediate mold portion;
placing one or more spar caps atop, at least, the custom intermediate mold portion and the reusable spar fixture;
placing one or more blade skins in the custom intermediate mold portion and/or around at least a portion of the one or more spar caps;
placing at least one second blade segment around at least a portion of the one or more spar caps atop the reusable spar fixture;
aligning the at least one first blade segment placed in the reusable first mold portion with a first end of the one or more blade skins placed in the custom intermediate mold portion;
aligning a second end of the one or more blade skins placed in the custom intermediate mold portion with a first end of the at least one second blade segment placed around at least the portion of the one or more spar caps atop the reusable spar fixture;
providing a vacuum only within the custom intermediate mold portion; and
infusing the one or more blade skins under the vacuum with a resin to join the at least one first blade segment, the one or more blade skins, and the at least one second blade segment together to form the rotor blade.
Clause 2. The method of clause 1, wherein aligning the at least one first blade segment placed in the reusable first mold portion with the first end of the one or more blade skins placed in the custom intermediate mold portion further comprises placing the first end of the one or more blade skins within the reusable first mold portion.
Clause 3. The method of clauses 1-2, further comprising providing the vacuum only within the custom intermediate mold portion and not to remaining portions of the mold assembly.
Clause 4. The method of any of the preceding clauses, wherein the reusable first mold portion is a reusable blade root mold and the at least one first blade segment comprises a prefabricated root section.
Clause 5. The method of any of the preceding clauses, wherein the at least one second blade segment comprises a blade tip section.
Clause 6. The method of any of the preceding clauses, wherein the reusable spar fixture is a rod-shaped member.
Clause 7. The method of any of the preceding clauses, wherein, after the infusing, the one or more blade skins infused with the resin form at least one of a trailing edge segment, a leading edge segment, a suction side segment, a pressure side segment, or combinations thereof.
Clause 8. A method of manufacturing a rotor blade of a wind turbine using a mold assembly, the method comprising:
placing and securing a reusable spar fixture of the mold assembly within a custom mold portion of the mold assembly, the custom mold portion extending from a first end to a second end, the reusable spar fixture extending beyond the second end of the custom mold portion;
placing one or more spar caps atop, at least, the custom mold portion and the reusable spar fixture;
placing one or more blade skins in the custom mold portion and/or around at least a portion of the one or more spar caps;
placing at least one blade segment around at least a portion of the one or more spar caps atop the reusable spar fixture;
aligning an end of the one or more blade skins placed in the custom mold portion with an end of the at least one blade segment placed around at least the portion of the one or more spar caps atop the reusable spar fixture;
providing a vacuum only within the custom mold portion; and
infusing the one or more blade skins under the vacuum with a resin to join the one or more blade skins and the at least one blade segment together to form the rotor blade.
Clause 9. The method of clause 8, further comprising:
placing the custom mold portion at least partially within a reusable mold portion, wherein the reusable mold portion is a reusable blade root mold and the at least one blade segment comprises a prefabricated root section;
placing at least one prefabricated root section in the reusable blade root mold of the mold assembly; and
co-infusing the at least one prefabricated blade root section with the one or more blade skins.
Clause 10. The method of clause 9, wherein the at least one blade segment comprises a blade tip section.
Clause 11. The method of clauses 8-10, wherein the reusable spar fixture is a rod-shaped member.
Clause 12. The method of clauses 8-11, wherein, after the infusing, the one or more blade skins infused with the resin form at least one of a trailing edge segment, a leading edge segment, a suction side segment, a pressure side segment, or combinations thereof.
Clause 13. A mold assembly for manufacturing a rotor blade of a wind turbine, the mold assembly comprising:
a reusable first mold portion;
a custom intermediate mold portion defining a custom contoured surface corresponding to a portion of an exterior surface of the rotor blade, the custom intermediate mold portion extending from a first end and a second end, the first end being received and supported within the reusable first mold portion, the custom intermediate mold portion configured to receive one or more blade skins;
an infusion apparatus comprising a resin for infusing the one or more blade skins and a vacuum assembly for applying a vacuum only to the custom intermediate mold portion to draw the resin into the one or more blade skins; and
a reusable spar fixture secured within the custom intermediate mold portion,
wherein a portion of the reusable spar fixture extends past the second end of the custom intermediate mold portion to support at least one of one or more spar caps or one or more blade segments thereon during the manufacturing of the rotor blade.
Clause 14. The mold assembly of clause 13, wherein the vacuum is applied only within the custom intermediate mold portion and not to remaining portions of the mold assembly.
Clause 15. The mold assembly of clauses 13-14, wherein the infused one or more blade skins with the resin form at least one of a trailing edge segment, a leading-edge segment, a suction side segment, a pressure side segment, or combinations thereof, of the rotor blade.
Clause 16. The mold assembly of clauses 13-15, wherein the reusable first mold portion is a reusable blade root mold, the reusable blade root mold configured to support a prefabricated root section.
Clause 17. The mold assembly of clauses 13-16, wherein the one or more blade segments comprise, at least, prefabricated a blade tip section.
Clause 18. The mold assembly of clauses 13-17, wherein the reusable spar fixture is a rod-shaped member.
Clause 19. The mold assembly of clauses 13-18, wherein the reusable spar fixture is constructed of a metal material.
Clause 20. The mold assembly of clauses 13-19, further comprising a support structure arranged beneath the reusable spar fixture for supporting the portion of the reusable spar fixture extending beyond the custom intermediate mold portion.

The skilled artisan will recognize the interchangeability of various features from different embodiments. Similarly, the various method steps and features described, as well as other known equivalents for each such methods and feature, can be mixed and matched by one of ordinary skill in this art to construct additional systems and techniques in accordance with principles of this disclosure. Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While only certain features of the invention have been illustrated and described herein, many modifications and changes will occur to those skilled in the art. It is, therefore, to be understood that the appended claims are intended to cover all such modifications and changes as fall within the true spirit of the invention.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of manufacturing a rotor blade of a wind turbine using a mold assembly, the method comprising:
placing at least one first blade segment in a reusable first mold portion of the mold assembly;
placing and securing a reusable spar fixture of the mold assembly within a custom intermediate mold portion of the mold assembly, the custom intermediate mold portion extending from a first end to a second end, the reusable spar fixture extending beyond the second end of the custom intermediate mold portion;
placing one or more spar caps atop, at least, the custom intermediate mold portion and the reusable spar fixture;
placing one or more blade skins in the custom intermediate mold portion and/or around at least a portion of the one or more spar caps;
placing at least one second blade segment around at least a portion of the one or more spar caps atop the reusable spar fixture;
aligning the at least one first blade segment placed in the reusable first mold portion with a first end of the one or more blade skins placed in the custom intermediate mold portion;
aligning a second end of the one or more blade skins placed in the custom intermediate mold portion with a first end of the at least one second blade segment placed around at least the portion of the one or more spar caps atop the reusable spar fixture;
providing a vacuum only within the custom intermediate mold portion; and
infusing the one or more blade skins under the vacuum with a resin to join the at least one first blade segment, the one or more blade skins, and the at least one second blade segment together to form the rotor blade.

2. The method of claim 1, wherein aligning the at least one first blade segment placed in the reusable first mold portion with the first end of the one or more blade skins placed in the custom intermediate mold portion further comprises placing the first end of the one or more blade skins within the reusable first mold portion.

3. The method of claim 1, further comprising providing the vacuum only within the custom intermediate mold portion and not to remaining portions of the mold assembly.

4. The method of claim 1, wherein the reusable first mold portion is a reusable blade root mold and the at least one first blade segment comprises a prefabricated root section.

5. The method of claim 1, wherein the at least one second blade segment comprises a blade tip section.

6. The method of claim 1, wherein the reusable spar fixture is a rod-shaped member.

7. The method of claim 1, wherein, after the infusing, the one or more blade skins infused with the resin form at least one of a trailing edge segment, a leading edge segment, a suction side segment, a pressure side segment, or combinations thereof.

8. A method of manufacturing a rotor blade of a wind turbine using a mold assembly, the method comprising:
placing and securing a reusable spar fixture of the mold assembly within a custom mold portion of the mold assembly, the custom mold portion extending from a first end to a second end, the reusable spar fixture extending beyond the second end of the custom mold portion;
placing one or more spar caps atop, at least, the custom mold portion and the reusable spar fixture;
placing one or more blade skins in the custom mold portion and/or around at least a portion of the one or more spar caps;
placing at least one blade segment around at least a portion of the one or more spar caps atop the reusable spar fixture;
aligning an end of the one or more blade skins placed in the custom mold portion with an end of the at least one blade segment placed around at least the portion of the one or more spar caps atop the reusable spar fixture;
providing a vacuum only within the custom mold portion; and
infusing the one or more blade skins under the vacuum with a resin to join the one or more blade skins and the at least one blade segment together to form the rotor blade.

9. The method of claim 8, further comprising:
placing the custom mold portion at least partially within a reusable mold portion, wherein the reusable mold portion is a reusable blade root mold and the at least one blade segment comprises a prefabricated root section;
placing at least one prefabricated root section in the reusable blade root mold of the mold assembly; and
co-infusing the at least one prefabricated blade root section with the one or more blade skins.

10. The method of claim 9, wherein the at least one blade segment comprises a blade tip section.

11. The method of claim 8, wherein the reusable spar fixture is a rod-shaped member.

12. The method of claim 8, wherein, after the infusing, the one or more blade skins infused with the resin form at least one of a trailing edge segment, a leading edge segment, a suction side segment, a pressure side segment, or combinations thereof.

13. A mold assembly for manufacturing a rotor blade of a wind turbine, the mold assembly comprising:
a reusable first mold portion;
a custom intermediate mold portion defining a custom contoured surface corresponding to a portion of an exterior surface of the rotor blade, the custom intermediate mold portion extending from a first end and a second end, the first end being received and supported within the reusable first mold portion, the custom intermediate mold portion configured to receive one or more blade skins;
an infusion apparatus comprising a resin for infusing the one or more blade skins and a vacuum assembly for applying a vacuum only to the custom intermediate mold portion to draw the resin into the one or more blade skins; and
a reusable spar fixture secured within the custom intermediate mold portion,
wherein a portion of the reusable spar fixture extends past the second end of the custom intermediate mold portion to support at least one of one or more spar caps or one or more blade segments thereon during the manufacturing of the rotor blade.

14. The mold assembly of claim 13, wherein the vacuum is applied only within the custom intermediate mold portion and not to remaining portions of the mold assembly.

15. The mold assembly of claim 13, wherein the infused one or more blade skins with the resin form at least one of a trailing edge segment, a leading-edge segment, a suction side segment, a pressure side segment, or combinations thereof, of the rotor blade.

16. The mold assembly of claim 13, wherein the reusable first mold portion is a reusable blade root mold, the reusable blade root mold configured to support a prefabricated root section.

17. The mold assembly of claim 13, wherein the one or more blade segments comprise, at least, prefabricated a blade tip section.

18. The mold assembly of claim 13, wherein the reusable spar fixture is a rod-shaped member.

19. The mold assembly of claim 13, wherein the reusable spar fixture is constructed of a metal material.

20. The mold assembly of claim 13, further comprising a support structure arranged beneath the reusable spar fixture for supporting the portion of the reusable spar fixture extending beyond the custom intermediate mold portion.
